(19) United States
(12) Patent Application Publication
(10) Pub. No.: US 2014/0024424 A1
(43) Pub. Date: Jan. 23, 2014

(54) Multi-Stage High-Low Card Game System and Method

(71) Applicant: Douglas Cohen, Pittsburgh, PA (US)

(72) Inventor: Douglas Cohen, Pittsburgh, PA (US)

(21) Appl. No.: 13/738,338

(22) Filed: Jan. 10, 2013

Related U.S. Application Data
(60) Provisional application No. 61/646,505, filed on May 14, 2012.

(51) Int. Cl. G07F 17/32

(52) U.S. Cl. CPC G07F 17/3293
USPC 463/11; 273/292

(57) ABSTRACT

Provided is a method for a multi-staged high-low game having a plurality of stages, each stage of the plurality of stages comprising a plurality of cards associated with a plurality of guesses, wherein each stage ends when the plurality of cards are provided without a player making an incorrect guess, and wherein each end of each stage is associated with a payment, the method comprising the steps of providing a physical gaming surface; providing, on the physical gaming surface, the plurality of cards for each stage of the plurality of stages, wherein each stage comprises providing each card of the plurality of cards after a guess of high or low is made by the player and removing the wager if conditions if the player guesses incorrectly. Payments are provided at predetermined intervals if the player continues to guess correctly. An electronic game and a physical gaming apparatus are also disclosed.

### CROSS REFERENCE TO RELATED APPLICATIONS

This application claims benefit of priority from U.S. Provisional Patent Application No. 61/646,505, filed May 14, 2012, which is incorporated herein by reference in its entirety.

### BACKGROUND OF THE INVENTION

1. Field of the Invention

This invention relates generally to card games and, more specifically, to a method and apparatus for providing a multi-stage high-low card game.

2. Description of Related Art

Many traditional casino card games, such as blackjack, offer one-to-one or similar odds for players, and do not offer large payouts for bets as do other table games, such as craps or roulette. Additionally, traditional casino card games often involve games with discreet hands that determine whether a player has won or lost, and do not allow players to exponentially increase their possible winnings by parlaying the payouts of several successful hands in succession.

Traditional casino card games also lack a sense of camaraderie and excitement between players, as is often presented in the game of craps. This is because, in blackjack for instance, players' choices have an effect on the next card drawn, essentially pressuring players into playing according to a predefined set of rules in order to maintain the expectations of other players. Further, many players do not win or lose together in traditional casino card games.

### SUMMARY OF THE INVENTION

It is, therefore, an object of the present invention to provide a system, method, and apparatus for providing a game that overcomes the drawbacks and deficiencies of the prior art. According to one preferred and non-limiting embodiment of the present invention, provided is a method for providing a multi-stage high-low game, including the steps of: (a) providing a physical gaming surface; (b) providing, on the physical gaming surface, a card comprising a value; (c) providing, on the physical gaming surface, a next card comprising a value, wherein the next card is provided after an indication of high or low is received; (d) repeating step (c) until at least one of the following occurs: the indication is low and the value of the next card is greater than the value of the next card previously provided, the indication is high and the value of the next card is less than the value of the next card previously provided, or a predetermined number of next cards are provided; (e) providing at least one unit of payment to at least one player; (f) repeating step (c) until at least one of the following occurs: the indication is low and the value of the next card is greater than the value of the next card previously provided, the indication is high and the value of the next card is less than the value of the next card previously provided, or a second predetermined number of next cards are provided; and (g) providing at least one second unit of payment to the at least one player, wherein the at least one second unit of payment has a value that is greater than a value of the at least one unit of payment.

According to another preferred and non-limiting embodiment of the present invention, provided is a method for providing a high-low card game having a plurality of stages, each stage of the plurality of stages including a predetermined number of cards, wherein each stage ends after the predetermined number of cards are provided without a player losing a wager, and wherein each end of each stage is associated with a payment, the method including the steps of: providing a physical gaming surface; providing, on the physical gaming surface after the player makes the wager, the predetermined number of cards for each stage of the plurality of stages, wherein each stage comprises providing each card of the predetermined number of cards after an indication of high or low is made by the player and removing the at least one wager if at least one of the following occurs: the player indicated low and a next card of the plurality of cards provided has a value higher than a value of a card previously provided, or the player indicated high and the next card of the plurality of cards provided has a value higher than the value of the card previously provided; and providing a payment to the player at the end of each stage of the plurality of stages if the at least one wager has not yet been removed, wherein the payment is increased at every stage of the plurality of stages.

According to a further preferred and non-limiting embodiment, provided is a multi-stage high-low game, including: a plurality of indicator units, each indicator unit of the plurality of indicator units configured to provide an indication of high or low; a physical gaming surface comprising a player-side portion and a dealer-side portion, the player-side portion comprising a plurality of betting grids positioned in a plurality of player positions, the dealer-side portion comprising a plurality of indicia adapted for receiving a plurality of playing cards, the plurality of playing cards including a predetermined number of playing cards for each stage of the game, wherein each betting grid of the plurality of betting grids comprises a plurality of betting portions adapted to receive at least one wagering unit, and a plurality of payment portions adapted to receive a plurality of incremental payments.

According to another preferred and non-limiting embodiment, provided is a computer-implemented method for providing a virtual multi-stage high-low game, including the steps of: (a) displaying a virtual gaming surface with at least one display device; (b) displaying, on the virtual gaming surface, a graphical representation of a card associated with a value; (c) displaying, on the virtual gaming surface, a graphical representation of a next card associated with a value, wherein the graphical representation of the next card is displayed after an indication of high or low is received; (d) repeating step (c) until at least one of the following occurs: the indication is low and the value of the next card is greater than the value of the card or the next card previously displayed, the indication is high and the value of the next card is less than the value of the card or the next card previously displayed, or a predetermined number of next cards are displayed; (e) allocating at least one first unit of payment to an electronic player balance for at least one player; (f) repeating step (c) until at least one of the following occurs: the indication is low and the value of the next card is greater than the value of the next card previously displayed, the indication is high and the value of the next card is less than the value of the next card previously displayed, or a second predetermined number of next cards are displayed; and (g) allocating at least one second unit of payment to the electronic player balance, wherein the at least one second unit of payment has a value that is greater than a value of the at least one first unit of payment.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 illustrates a gaming surface for providing a multi-stage high-low game according to the principles of the present invention;

FIGS. 2A-H illustrate betting grids during various stages of a multi-stage high-low game according to the principles of the present invention;

FIGS. 3A and 3B illustrate two sides of an indicator unit for a multi-stage high-low game according to the principles of the present invention;

FIG. 4 is a flow diagram for a method for providing a multi-stage high-low game according to the principles of the present invention; and

FIG. 5 is a block diagram of a computer and network environment according to the prior art.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention is a multi-stage high-low card game that is easy to learn, yet exciting to play. The game incorporates many of the positive aspects of other popular casino games, such as blackjack, roulette, and craps, to create an exciting game with tension and suspense. The present invention, in some non-limiting embodiments, presents many advantages for casinos, with determinable odds, player excitement, and fast game play.

One aspect of the game, in some embodiments, is the action and pace. In one non-limiting embodiment, players make many decisions over a short period of time and are kept involved so long as they are still in the hand. Even within one hand, a player stands to make as many as fifteen different decisions, all of which may affect the outcome of the hand for that player. Yet, depending on how the game is played, some hands may last for only a few minutes, and other hands may last less than that. This pace keeps the intensity up, but maintains fairly simple decisions on players' behalves, lessening the anxiety. A subsequent hand is always moments away. However, it will be appreciated that the multi-stage high-low game of the present invention may be provided with any number of timings and/or pacing.

In one non-limiting embodiment, a pay-out multiplier is provided as part of the game, allowing a player to win large sums of money without having to risk an overwhelming sum. A player going successfully “Around the World” (i.e., staying in the game for the entire hand) may win ten times his original bet, as an example, without doubles, which will be explained herein. Accounting for doubles, the total could be much higher. A player is able to sit down with a small amount and walk away with a large payout.

Another desirable aspect of non-limiting embodiments of the game is the camaraderie that the game can provide between players at a game table. Even though, in a preferred and non-limiting embodiment, each player guesses independently from the other players, everyone in the hand is playing against the same upturned cards. Losing a hand is often less painful when players share each others' pain, and everybody at the casino can hear when a roll of the dice at the craps table makes a lot of people happy. In the game of the present invention, it may not be uncommon for everybody at the table to make the same guesses, and ride out their decisions together.

Embodiments of the game can be easy for players to learn. When getting people to buy into something new, it's important that they're not intimidated by it. Thus, embodiments of the game should be able to be picked up by some players after watching only a few hands. This appeals to both beginner and veteran casino-goers. Those less comfortable with gambling may find themselves more at ease playing a game without so many difficult rules. Veteran gamblers will be able to enjoy the straight-forward odds, which helps make blackjack so popular to them.

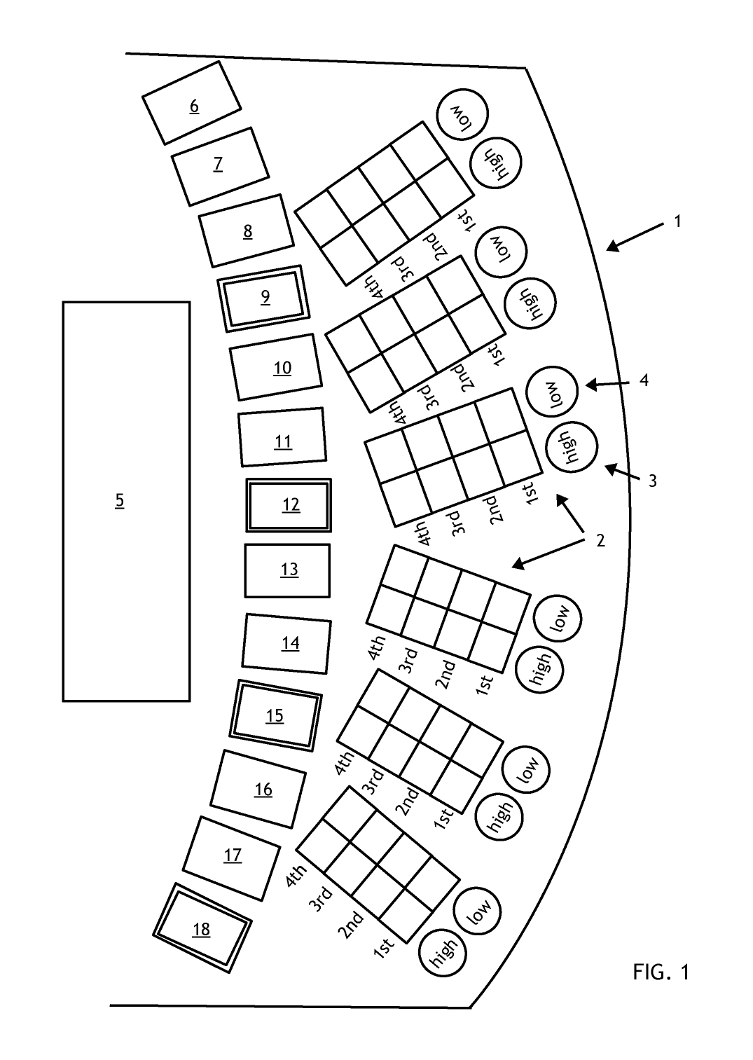

Referring now to FIG. 1, a physical gaming surface (e.g., gaming table) is shown according to one preferred and non-limiting embodiment of the present invention. The physical gaming surface may include one or more tables, table tops, table coverings, platforms, pieces of material, and/or the like. In the depicted embodiment, the gaming surface 1 includes a plurality of betting grids 2, a starting card portion 6, and a plurality of guess card portions 7-18. Guess card portions 9, 12, 15, and 18 are additionally designated as first, second, third, and fourth guess card payment portions, respectively. The portions may be printed on the gaming surface the size of a playing card or larger, or may be unmarked portions of the gaming surface that the cards are provided on. The betting grids 2 each include, as an example, a two (2) by four (4) grid representing eight (8) portions. The gaming surface 1 may further include an area for a dealer's bank 5. Various other arrangements are possible.

With continued reference to FIG. 1, a plurality of high-low indicator portions 3, 4 are represented: a high indicator portion 3 and a low indicator portion 4. In the illustrated example, the high-low indicator portions are on (e.g., printed on, adhered to, or integrated with) the gaming surface 1. In a preferred and non-limiting embodiment, a high-low indicator unit 30 (not shown) is provided that may be placed on either the high or low indicator portions 3, 4. The high-low indicator unit 30 may be a physical disk having two sides, each marked to indicate a guess of higher or lower. It will be appreciated that the high-low indicator unit 30 may take on any number of forms for displaying or otherwise indicating a choice of at least two options by a player, including physical game pieces and/or electronic indication means provided on the physical gaming surface (e.g., buttons, switches, touchscreens, and/or the like). In one preferred but non-limiting embodiment, the high-low indicator unit 30 is used during gameplay by players to indicate a guess of high or low. In one embodiment, the player's indication is doubly displayed: once with the high-low indicator unit 30, which has a high side 31 and a low side 34, and once by the placement of the indicator unit on either high or low indicator portions 3, 4. It will be appreciated that players may make indications by various other means, including predefined chip (wager) placement patterns and the like.

In one preferred and non-limiting embodiment, the game of the present invention is played with one or more physical decks of playing cards. Players start by placing a wager (e.g., a token, chip, unit of currency or other indication of participation) on a portion of the betting grid 2. In one non-limiting embodiment, the wager is placed on a bottom rectangle of the grid, closest to the player, in a column designed as a “bet line.” A card is dealt into the starting card portion 6, such that the players are able to discern its value (i.e., suit, number, and/or both). The players then use the high-low indicator unit 30, or other means, to indicate whether the next card dealt will have a value that is higher or lower than that of the starting card, placing the indicator unit on the gaming surface 1 and, in one embodiment, on the high or low indicator portions 3, 4 corresponding to the choice. A next card is now dealt into the first guess card portion 7, such that its value is also able to be discerned. If the value of the next card is higher than that of the starting card, those players that guessed “high” or “higher” may continue to play the hand. Those players that chose “low” or “lower” will have their wagers collected by the dealer and, in a preferred but non-limiting embodiment, will be excluded from the remainder of the hand. However, it will be appreciated that the game of the present invention may be implemented in a way to allow players to make a new wager and continue playing.

If there are players remaining in the hand, they may make another indication of high or low before a subsequent card is dealt and, this time, placed on a second guess card portion 8. Again, the players that guessed correctly stay in the game (hand), and those that guessed incorrectly may be excluded.

The process is repeated again, this time with the next card being dealt to the third guess card portion 9 corresponding with the first guess card payment portion. Players that guessed correctly on this card are paid out proportionally to their bet, as an example. In one non-limiting embodiment, the pay-out at the first pay-out guess card portion 9 is one-to-one, and the dealer places the players' winnings on their respective betting grids 2 on the pay line. In one example, the winnings are placed next to the wager in the betting grid, in a column designated as a “pay line.”

At this point in the hand, any player still active may collect the winnings and end their respective participation in the game. Those players that continue to play after the first pay-out guess card have their bets moved up one place in the betting grid 2 in the column designated as the “bet line.” This action may be performed by the players or the dealer, depending on how the game is implemented. Further, it will be appreciated that various other arrangements are possible. For example, the winnings may be placed on top or in front of the wager, or may be placed alongside the wager without the presence of a betting grid.

The game then continues as before, progressing from the third guess card portion 9 to the twelfth guess card portion 18. As with the first three guess cards, the players continuing to play must guess whether each card dealt will be higher or lower than the preceding card. At the sixth guess card portion 12 (i.e., the second guess card payment portion), the players still in the hand may be paid out at a higher rate than the pay-out for the first pay-out guess card (e.g., two-to-one). Players that continue to guess successfully may continue “Around the World” to the fourth pay-out guess card at the twelfth guess card portion 18. The third guess card payment portion 15 may pay-out three-to-one and the fourth guess card payment portion 18 may pay players four-to-one, as examples.

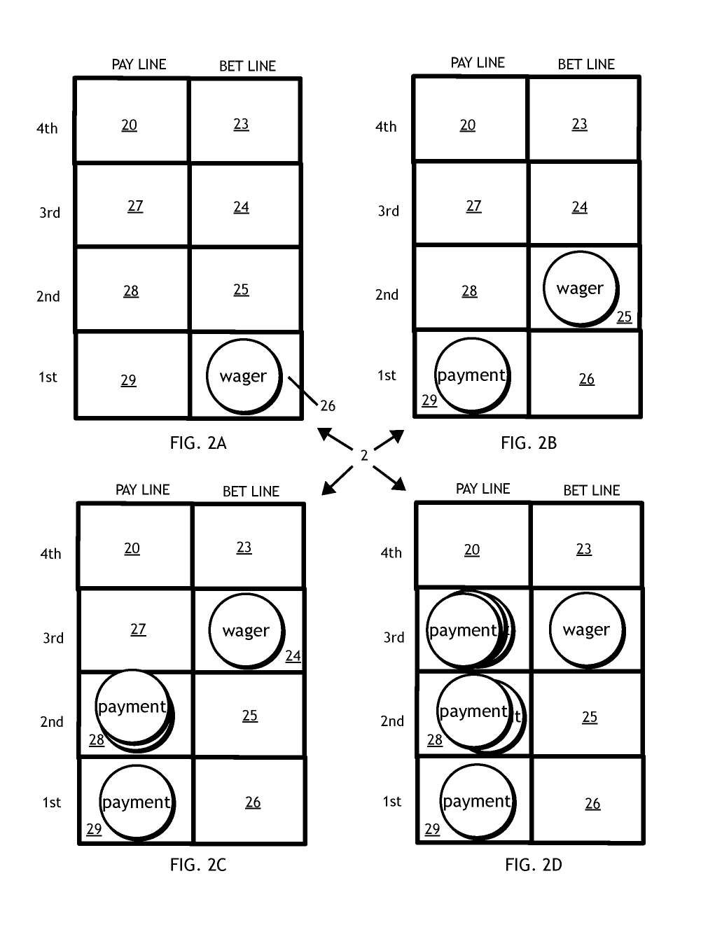

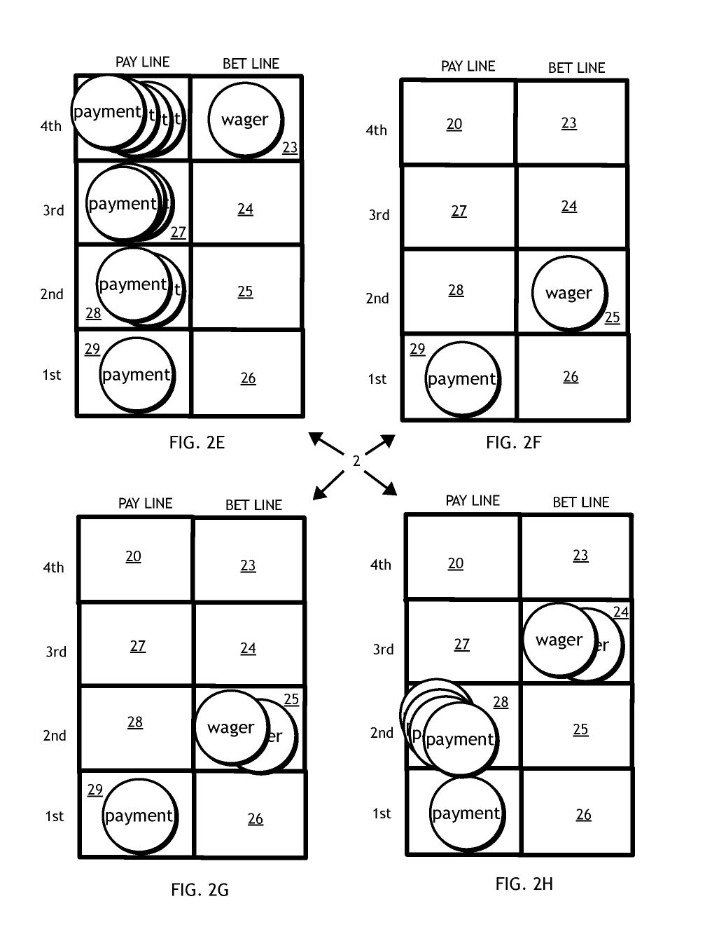

Referring now to FIGS. 2A-H, shown is a betting grid 2 according to one preferred and non-limiting embodiment of the present invention. Referring to FIG. 2A, the betting grid 2 depicted is a two (2) by four (4) grid with four (4) pay/win portions (the pay line) 20, 27, 28, 29, and four (4) betting portions (the bet line) 23, 24, 25, 26. It will be appreciated that the betting grid 2 may include any number of portions in any arrangement. In a preferred and non-limiting embodiment, the betting grid 2 portions are used to move a player's wager (e.g., tokens, chips, currency, or other representation) from, for example, betting portion 26 to betting portion 25 after the player surpasses the first pay-out guess card and proceeds to the next stage of the hand. A player's winnings at each stage may be placed on pay/win portions 20, 27, 28, 29.

With continued reference to FIGS. 2A-E, a winning round is shown according to one preferred and non-limiting embodiment. In FIG. 2A, a wager is placed on a first betting portion 26 to begin the game. Once the player completes a stage of the game, reaching the first pay-out guess card successfully which, as described, may be the third guess card in some non-limiting embodiments, the round moves to FIG. 2B. As shown in FIG. 2B, a first payment is provided on the “pay line” column of the betting grid 2, and specifically a first pay/win portion 29, and the wager is moved to a next betting portion 25 of the betting grid 2. After the payment is provided, but before the wager is moved in the betting grid, the player may be given an option to take the winnings and the wager and leave the table. In the example depicted in 2A-E, the player continues playing through all rounds.

Referring to FIGS. 2F-H, a version of a non-limiting embodiment of the game in which a “double” occurs is shown. In FIG. 2F, a player has been paid on a first stage and has proceeded to the second stage. If, before the second pay-out card is reached, a “double” occurs (i.e., the value of the next card is equal to the value of the previous card), the player may be given the option to double the wager. In FIG. 2G, the player's wager is doubled and, when the second pay-out card is reached, the payment is doubled. As can be see in FIG. 2H, after the second stage is completed, the double wager is moved to a next portion of the betting grid 2 for a third stage.

Referring to FIGS. 2B-C, a player at the stage shown in FIG. 2B may continue until the second pay-out guess card, if successful in indicating high or low, and receive a second payment on a second pay/win portion 28, as shown in FIG. 2C. The wager shown in FIG. 2C is advanced another portion (i.e., to a third betting portion 24) in the betting grid 2 for a third stage of the game. As can be seen in FIG. 2C, the second payment is greater than the first payment. Referring now to FIG. 2D, a third stage is shown in which the player reaches the third pay-out guess card and a third payment is provided in a further portion (i.e., a third pay/win portion 27) of the betting grid 2. As already described, the player may be given the option to take all of the winnings at this point and walk away, or to proceed to the fourth stage. If the player moves on, the wager gets moved to a further portion (i.e., a fourth betting portion 23) of the betting grid 2. Referring to FIG. 2E, a fourth payment is provided in a further portion (i.e., a fourth pay/win portion 20) of the “pay line” in the betting grid 2 if the player reaches the fourth pay-out guess card and completes the fourth stage. In the depicted non-limiting embodiment, the game ends at this stage and the player keeps the payments and the wager. However, if, between FIG. 2D and FIG. 2E, the player does not guess correctly on a non-pay-out card, the player loses all of the payments in the betting grid 2 as well as the wager.

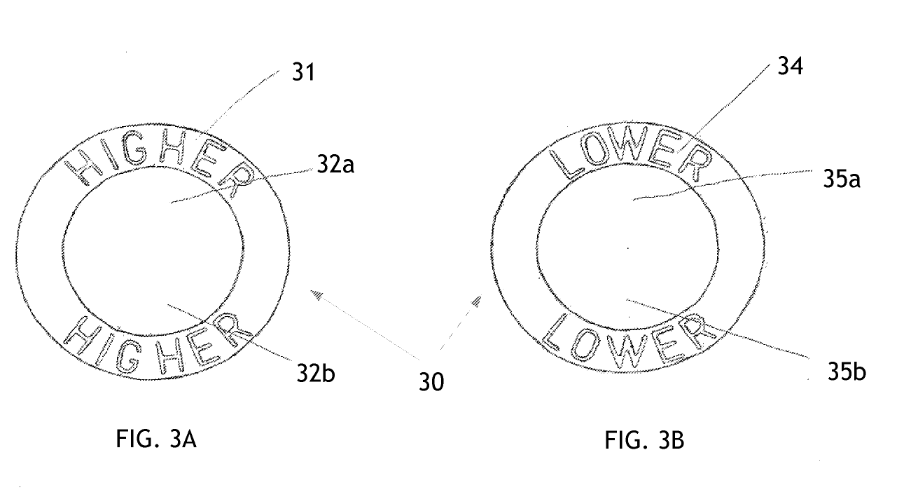

Referring now to FIGS. 3A and 3B, a high-low indicator unit 30 is shown according to one preferred and non-limiting embodiment of the present invention. FIG. 3A illustrates a first side 31 of the indicator unit and FIG. 3B illustrates a second side 34 of the indicator unit. In one embodiment, the first side 31 of the indicator unit indicates a “higher” guess by a player and may include, for example, logo areas 32a and 32b that may have a logo associated with the game and/or with a casino/establishment. Likewise, the second side 34 of the indicator unit 30 may indicate a “lower” guess by a player and may also include logo areas 35a and 35b that may have any number of logos. The indicator unit 30 may be the sole way for players to indicate their guesses to dealers, or may be combined with high-low indicator portions 3, 4 on the gaming surface 1 (shown in FIG. 1) to further indicate a player's choice.

In one preferred and non-limiting embodiment, if the next card dealt matches the previous card (i.e., having the same value), a “double” occurs. At this point, players are permitted to double their wagers, and the next card dealt will be dealt on top of the double card, replacing it.

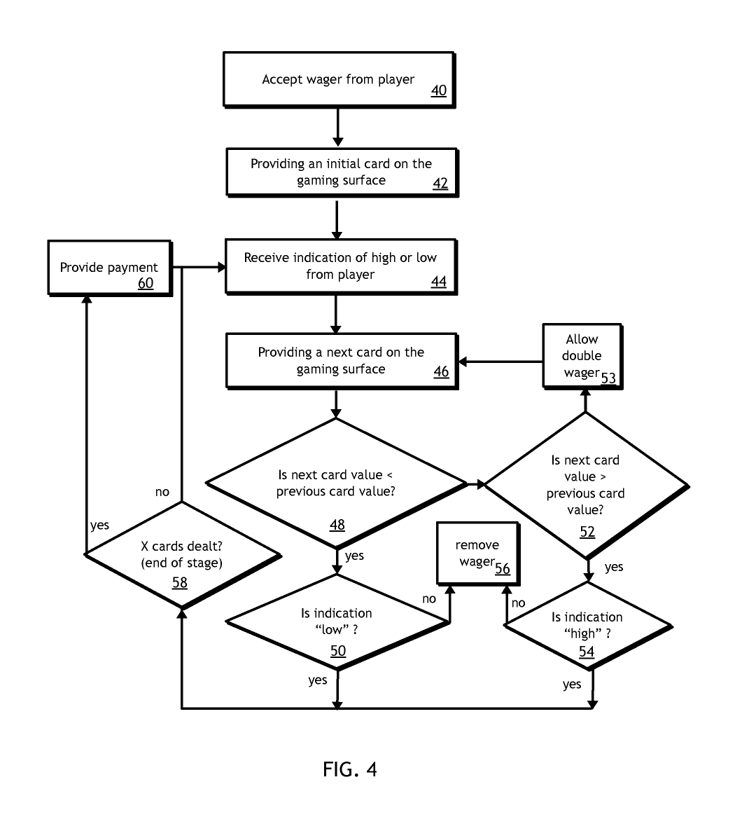

Referring now to FIG. 4, a method for providing a multi-stage high-low card game is shown according to one preferred and non-limiting embodiment. At a first step 40, a dealer accepts a wager from one or more players. After all wagers are made, an initial card is provided on the gaming surface at a next step 42. After the initial card is displayed, a player makes an indication of a high or low guess—i.e., whether the next card dealt will have a value higher or lower than that of the initial card—at a next step 44. After an indication is made, at a next step 46, a next card is provided on the gaming surface. At step 48, if the next card provided has a value less than the previous card (i.e., the initial card or the previous next card), the method proceeds to step 50 and it is determined whether the player's indication (or each of the indications for each player of a number of players) is correct. If the player did not guess low, the method proceeds to step 56 and the player's (or players') wagers are removed and the game ends.

Still referring to FIG. 4, at step 50, if the player correctly guessed low, the method proceeds to step 58 where it is determined how many cards have been dealt (or how many guesses have been made), and whether a payment should be made. For example, in an embodiment where every third card (or third guess) is a pay-out card, X (representing the number of cards in each stage) equals three (3). However, various values of X are possible. If the stage is not over (i.e., X cards have not been dealt or X guesses have not been made), the method proceeds back to step 44 and another next card is provided and the process is repeated as depicted. At step 48, if the next card is not less than the previously dealt card, the method proceeds to step 52 where it is determined if the next card has a value greater than the previously dealt card. If not, the values are equal (i.e., a “double” has occurred) and the player is allowed to double their wager at step 53.

With continued reference to FIG. 4, a new next card is then provided at step 46 and may, for example, be placed on the previous card or in a new space (portion) on the gaming surface. If the next card has a value greater than the previously dealt card at step 52, the method proceeds to step 54 where it is determined if the player made the correct indication. If the player or players indicated a high guess, they are correct and the method proceeds to step 58 as previously described. If the player or players made a wrong guess (i.e., a low guess and the value of the next card is higher than the previously dealt card), the method proceeds to step 56 where the wager is removed and the game ends.

For purposes of explaining the present invention, an example hand will be described in detail. However, it is noted that the following example is meant to be illustrative of one non-limiting embodiment of the present invention and one possible permutation of cards/guesses. It will be appreciated that the present invention may be implemented with any number of players, wager amounts, or gaining surfaces.

To begin, five players start a hand of the card game of the present invention. The players are situated around a gaming surface such as that illustrated in FIG. 1. Player 1 sits furthest to the dealer's left. Player 2 sits to Player l's left. Player 3 sits to Player 2's left. Player 4 sits to Player 3's left. Player 5 sits to Player 4's left. The dealer deals with all player actions from his left to right.

Player 1 bets $5, placing his chips in the first bet portion 26 on the betting grid in front of him. Player 2 bets $5, placing his chips in the first bet portion 26 on the betting grid in front of him. Player 3 bets $10, placing his chips in the first bet portion 26 on the betting grid in front of him. Player 4 bets $10, placing his chips in the first bet portion 26 on the betting grid in front of him. Player 5 bets $10, placing his chips in the first bet portion 26 on the betting grid in front of him.

Once all bets are in, the dealer reveals the starting card, placing it on the starting card portion 6. The card is a three (3) of clubs.

Player 1 indicates his guess is higher, placing the high-low indicator unit 30 in the high-guess indication portion 3 in front of him, with the high-guess side 31 facing up. Player 2 indicates his guess is higher, placing the high-low indicator unit 30 in the high-guess indication portion 3 in front of him, with the high-guess side 31 facing up. Player 3 indicates his guess is higher, placing the high-low indicator unit 30 in the high-guess indication portion 3 in front of him, with the high-guess side 31 facing up. Player 4 indicates his guess is higher, placing the high-low indicator unit 30 in the high-guess indication portion 3 in front of him, with the high-guess side 31 facing up. Player 5 indicates his guess is higher, placing the high-low indicator unit 30 in the high-guess indication portion 3 in front of him, with the high-guess side 31 facing up.

Once all guesses are in, the dealer reveals the first guess card, placing it in the first guess card portion 7. The card is a six (6). Checking from left to right, all players have guessed correctly and can continue on in the hand.

Player 1 indicates his guess is higher, placing the high-low indicator unit 30 in the high-guess indication portion 3 in front of him, with the high-guess side 31 side up. Player 2 indicates his guess is higher, placing the high-low indicator unit 30 in the high-guess indication portion 3 in front of him, with the high-guess side 31 side up. Player 3 also indicates that his guess is higher, placing the high-low indicator unit 30 in the high-guess indication portion 3 in front of him, with the high-guess side 31 up. Player 4 indicates his guess is higher, placing the high-low indicator unit 30 in the high-guess indication portion 3 in front of him, with the high-guess side 31 up. Player 5 indicates his guess is lower, placing the high-low indicator unit 30 in the low-guess indication portion 4 in front of him, with the low-guess side 34 up.

Once all guesses are in, the dealer reveals the second guess card, placing it in the second guess portion 8. The card is a Jack. Checking from left to right, Players 1 through 4 have guessed correctly and can continue on in the hand. Player 5 has guessed incorrectly and he has lost the hand His $10 bet is taken and put in the dealer's bank 5, and he must wait for the next hand to start to play again.

Player 1 indicates his guess is lower, placing the high-low indicator unit 30 in the low-guess indication portion 4 in front of him, with the low-guess side 34 up. Player 2 indicates his guess is lower, placing the high-low indicator unit 30 in the low-guess indication portion 4 in front of him, with the low-guess side 34 up. Player 3 indicates his guess is lower, placing the high-low indicator unit 30 in the low-guess indication portion 4 in front of him, with the low-guess side 34 up. Player 4 also indicates his guess is lower, placing the high-low indicator unit 30 in the low-guess indication portion 4 in front of him, with the low-guess side 34 up.

Once all guesses are in, the dealer reveals the third guess card, placing it in the third guess portion 9, which is also the first guess card payment portion 9. The card is a ten (10). Checking from left to right, Player 1 has guessed correctly and can continue on in the hand. Reaching the first guess card payment portion 9 makes him a winner at a rate of 1 to 1 on his bet in the first bet portion 26. His winnings of $5 are placed by the dealer in the first payout portion 29 on the betting grid in front of him. Player 2 has guessed correctly and can continue on in the hand. Reaching the first guess card payment portion 9 also makes him a winner at a rate of 1 to 1 on his bet in the first bet portion 26. His winnings of $5 are placed by the dealer in the first payout portion 29 on the betting grid In front of him. Player 3 has guessed correctly and can continue on in the hand. Reaching the first guess card payment portion 9 makes him a winner at a rate of 1 to 1 on his bet in the first bet portion 26. His winnings of $10 are placed by the dealer in the first payout portion 29 on the betting grid in front of him. Player 4 has guessed correctly and can continue on in the hand. Reaching the first pay portion makes him a winner at a rate of 1 to 1 on his bet in the first bet portion 26. His winnings of $10 are placed by the dealer in the first payout portion 29 on the betting grid in front of him.

Players 1 through 3 all decide to continue on in the hand. However, Player 4 opts to end his hand at this juncture. He can do this at any guess card payment portion 9, 12, 15 during the game. Player 4 takes all money off his betting grid, and must wait until the next hand to play again. He has won $10, plus had his $10 bet returned to him.

The hand now continues on, the players basing their guesses on the last card revealed, which was a ten (10). The dealer moves all remaining players' bets from the first bet portion 26 to the second betting portion 25 on the betting grid. All accrued winnings remain on the betting grids of each player.

Player 1 indicates his guess is lower, placing the high-low indicator unit 30 in the low-guess indication portion 4 in front of him, with the low-guess side 34 up. Player 2 indicates his guess is lower, placing the high-low indicator unit 30 in the low-guess indication portion 4 in front of him, with the low-guess side 34 up. Player 3 indicates his guess is lower, placing the high-low indicator unit 30 in the low-guess indication portion 4 in front of him, with the low-guess side 34 up.

Once all guesses are in the dealer reveals the fourth guess card, placing it in the fourth guess portion 10. The card is a ten (10). This creates a “double”, since the fourth guess card matches the third guess card. Player 1 doubles his bet, placing $5 next to his bet in the second betting portion 25 on his betting grid, making his bet now $10. Player 2 doubles his bet, placing $5 next to his bet in the second betting portion 25 on his betting grid, making his bet now $10. Player 3 declines to double his bet. He is able to continue in the game for now, but must stop at the next guess card payment portion 12.

Player 1 indicates his guess is lower, placing the high-low indicator unit 30 in the low-guess indication portion 4 in front of him, with the low-guess side 34 up. Player 2 indicates his guess is lower, placing the high-low indicator unit 30 in the low-guess indication portion 4 in front of him, with the low-guess side 34 up. Player 3 indicates his guess is lower, placing the high-low indicator unit 30 in the low-guess indication portion 4 in front of him, with the low-guess side 34 up.

Once all guesses are in, the dealer reveals the next card, which is still considered the fourth guess card, and is placed on top of the other card in the fourth guess portion, making sure that both cards stay visible. This card is an eight (8). Checking from left to right, all players have guessed correctly and can continue on in the hand.

Player 1 indicates his guess is lower, placing the high-low indicator unit 30 in the low-guess indication portion 4 in front of him, with the low-guess side 34 up. Player 2 indicates his guess is higher, placing the high-low indicator unit 30 in the high-guess indication portion 3 in front of him, with the high-guess side 31 up. Player 3 indicates his guess is lower, placing the high-low indicator unit 30 in the low-guess indication portion 4 in front of him, with the low-guess side 34 up.

Once all guesses are in, the dealer reveals the fifth guess card, which is placed in the fifth guess portion 11. This card is a three (3). Checking from left to right, Player 1 has guessed correctly and can continue on in the hand. Player 2 has guessed incorrectly and he has lost the hand. His $10 bet is taken and put in the dealer's bank 5, as well as all winnings accrued and still in play on his betting grid. He must wait for the next hand to start to play again. Player 3 has guessed correctly and can continue on in the hand.

Player 1 indicates his guess is higher, placing the high-low indicator unit 30 in the high-guess indication portion 3 in front of him, with the high-guess side 31 up. Player 3 indicates his guess is higher, placing the high-low indicator unit 30 in the high-guess indication portion 3 in front of him, with the high-guess side 31 up.

Once all guesses are in, the dealer reveals the sixth guess card, placing it in the sixth guess portion 12, which is also the second guess card payment portion 12. The card is a King. Checking from left to right, Player 1 has guessed correctly and can continue on in the hand. Reaching the second guess card payment portion 12 makes him a winner at a rate of 2 to 1 on his bet in the second betting portion 25. His winnings of $20 are placed by the dealer in the second payout portion 28 on the betting grid in front of him. Player 3 has guessed correctly. Reaching the second guess card payment portion 12 makes him a winner at a rate of 2 to 1 on his bet in the second betting portion 25. His winnings of $20 are placed by the dealer in the second payout portion 28 on the betting grid in front of him. However, because he declined to double earlier in the hand, he must end his hand now. Player 3 takes all money off his betting grid and must wait until the next hand to play again. He has won $30 plus had his $10 bet returned to him.

Player 1 opts to continue on in the game. The hand now continues on, the players basing their guesses on the last card revealed, which was a King. The dealer moves all remaining players' bets from the second betting portion 25 to the third betting portion 24 on the betting grid. All accrued winnings remain on the betting grids of each player.

Player 1 indicates his guess is lower, placing the high-low indicator unit 30 in the low-guess indication portion 4 in front of him, with the low-guess side 34 up.

Once all guesses are in, the dealer reveals the seventh guess card, placing it in the seventh guess portion 13. This card is a 4. Player 1 has guessed correctly and can continue on in the hand.

Player 1 indicates his guess is higher, placing the high-low indicator unit 30 in the high-guess indication portion 3 in front of him, with the high-guess side 31 up.

Once all guesses are in, the dealer reveals the eighth guess card, placing it in the eighth guess portion 14. This card is a Queen. Player 1 has guessed correctly and can continue on in the hand.

Player 1 indicates his guess is lower, placing the high-low indicator unit 30 in the low-guess indication portion 4 in front of him, with the low-guess side 34 up.

Once all guesses are in, the dealer reveals the ninth guess card, placing it in the ninth guess portion 15, which is also the third guess card payment portion 15. The card is a two (2). Player 1 has guessed correctly and can continue on in the hand. Reaching the third guess card payment portion 15 makes him a winner at a rate of 3 to 1 on his bet in the third betting portion 24. His winnings of $30 are placed by the dealer in the third payout portion 27 on the betting grid in front of him.

Player 1 opts to continue. The hand now continues on, the players basing their guesses on the last card revealed, which was a two (2). The dealer moves all remaining players' bets from the third betting portion 24 to the fourth betting portion 23 on the betting grid. All accrued winnings remain on the betting grids of each player.

Player 1 indicates his guess is higher, placing the high-low indicator unit 30 in the high-guess indication portion 3 in front of him, with the high-guess side 31 up.

Once all guesses are in, the dealer reveals the tenth guess card, placing it in the tenth guess portion 16. This card is a three (3). Player 1 has guessed correctly and can continue on in the hand.

Player 1 indicates his guess is higher, placing the high-low indicator unit 30 in the high-guess indication portion 3 in front of him, with the high-guess side 31 up.

Once all guesses are in the dealer reveals the eleventh guess card, placing it in the eleventh guess portion 17. The card is a three (3). This creates another double. Player 1 doubles his bet, placing $10 next to his bet in the second betting portion 23 on his betting grid, making his bet now $20.

Player 1 indicates his guess is higher, placing the high-low indicator unit 30 in the high-guess indication portion 3 in front of him, with the high-guess side 31 up.

Once all guesses are in, the dealer reveals the next card, which is still considered the eleventh guess card, and is placed on top of the other card in the eleventh guess portion, making sure that both cards stay visible. This card is a nine (9). Player 1 has guessed correctly and can continue on in the hand.

Player 1 indicates his guess is lower, placing the high-low indicator unit 30 in the low-guess indication portion 4 in front of him, with the low-guess side 34 up.

Once all guesses are in the dealer reveals the twelfth guess card, placing it in the twelfth guess portion 18, which is also the fourth guess card payment portion 18. The card is a seven (7). Player 1 has guessed correctly. Reaching the fourth guess card payment portion 18 makes him a winner at a rate of 4 to 1 on his bet in the fourth betting portion 23 of the betting grid. His winnings of $80 are placed by the dealer in the fourth payout portion 20 on the betting grid in front of him.

This ends the game. Player 1 has successfully gone “Around the World”. Player 1 takes all money off his betting grid, and must wait until the next hand to play again. He has won $135, plus had his $20 bet returned to him. It will be appreciated that the game may be played in a various number of ways, and have different payouts and other aspects than those discussed in the above example.

The following tables respectively display the odds of reaching three guesses, two guesses, and a single guess in a row when starting with a card of a particular value. These tables approximate the possible outcomes of each guess in terms of correct and incorrect, without accounting for doubles. Further, these approximations do not account for cards remaining in the deck, nor does it account for any particular number of decks.

3 Correct Guesses

| | Winning | |
|---|---|---|
| Starting | Outcomes/Possible | |
| Card | Outcomes | Win % |
| A | 953/1728 | 55.15% |
| 2 | 858/1728 | 49.65% |
| 3 | 770/1728 | 44.56% |
| 4 | 692/1728 | 40.05% |
| 5 | 623/1728 | 36.05% |
| 6 | 559/1728 | 32.35% |
| 7 | 503/1728 | 29.11% |
| 8 | 559/1728 | 32.35% |
| 9 | 623/1728 | 36.05% |
| 10 | 692/1728 | 40.05% |
| J | 770/1728 | 44.56% |
| Q | 858/1728 | 49.65% |
| K | 953/1728 | 55.15% |
| Total | 9413/22464 | 41.90% |

2 Correct Guesses

| | Winning | |
|---|---|---|
| Starting | Outcomes/Possible | |
| Card | Outcomes | Win % |
| A | 108/144 | 75.00% |
| 2 | 97/144 | 67.36% |
| 3 | 87/144 | 60.42% |
| 4 | 78/144 | 54.17% |
| 5 | 70/144 | 48.61% |
| 6 | 63/144 | 43.75% |
| 7 | 57/144 | 39.58% |
| 8 | 63/144 | 43.75% |
| 9 | 70/144 | 48.61% |
| 10 | 78/144 | 54.17% |
| J | 87/144 | 60.42% |
| Q | 97/144 | 67.36% |
| K | 108/144 | 75.00% |
| Total | 1063/1872 | 56.78% |

1 Correct Guess

| | Winning | |
|---|---|---|
| Starting | Outcomes/Possible | |
| Card | Outcomes | Win % |
| A | 12/12 | 100.00% |
| 2 | 11/12 | 91.67% |
| 3 | 10/12 | 83.33% |
| 4 | 9/12 | 75.00% |
| 5 | 8/12 | 66.67% |
| 6 | 7/12 | 58.33% |
| 7 | 6/12 | 50.00% |
| 8 | 7/12 | 58.33% |
| 9 | 8/12 | 66.67% |
| 10 | 9/12 | 75.00% |
| J | 10/12 | 83.33% |
| Q | 11/12 | 91.67% |
| K | 12/12 | 100.00% |
| Total | 120/156 | 76.92% |

In one non-limiting embodiment of the present invention, the multi-stage high-low card game is provided electronically, using one or more computers or electronic devices. In this embodiment, visual/graphical representations of playing cards are provided on a user display device. Instead of a physical gaming surface, a graphical user interface is used. The various features discussed herein with regard to a physical casino game can be applied in a computer environment. Users may indicate their guess of high or low, wagers, decisions to double, and the like by choosing an appropriate icon or through other input (e.g., touchscreen, voice, keyboard input, and/or the like). The electronic game may be provided through a webpage, may be a localized application on a user computer, or may be a combination of both. However, it will be appreciated that the electronic game may take on any number of forms, such as a computer program product that is executable on a device having a processor. Program instructions executed by one or more processors facilitate the implementation of the game, and the determinations that would be made by a dealer in the physical embodiment of the game.

In one non-limiting embodiment, the electronic multi-stage high-low card game includes displaying a virtual gaming surface to a player with a display device. An initial virtual card is displayed after a player makes a wager using an account balance or by other means. A virtual betting grid may also be provided and may appear as a graphical representation of the betting grid described herein in relation to the physical embodiment of the multi-stage high-low game. Graphical representations of wagering units, cards, indicator units, and/or the like may be used in connection with the electronic embodiment of the multi-stage high-low game.

In one preferred and non-limiting embodiment, the electronic embodiment begins by a user inputting a wager, which may be an amount subtracted from a user balance or temporarily allocated. In one example, a graphical representation of a casino chip may be provided on a graphical representation of a betting grid. The virtual playing cards (i.e., graphical representations of playing cards or values thereof) may be provided on the display device, such that the players are able to discern its value (i.e., suit, number, and/or both). The players may then indicate, by clicking an icon, button, graphic, and/or the like, whether the next virtual card displayed will have a value that is higher or lower than that of the initial virtual card. A next card is now displayed on the virtual game surface, such that its value is also able to be discerned. If the value of the next virtual card is higher than that of the initial virtual card, those players that indicated that the next virtual card would be higher than the previous virtual card may continue to play the electronic game. Those players that indicated that the next virtual card would be lower than the previous virtual card may have their wagers cleared from the system and, in a preferred but non-limiting embodiment, will be excluded from the remainder of the round of the electronic game. However, it will be appreciated that the electronic game of the present invention may be implemented in a way to allow players to make a new wager and continue playing.

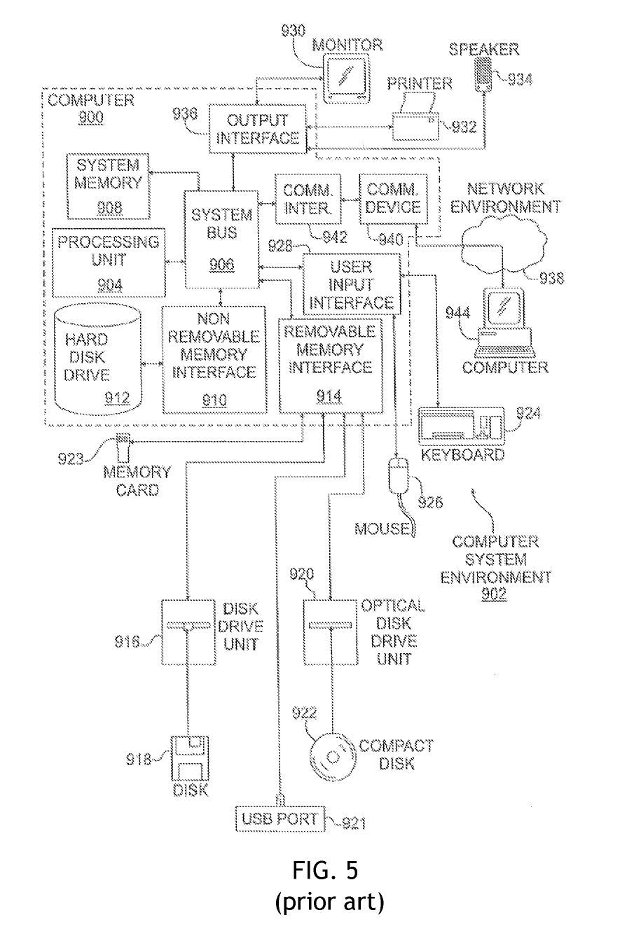

The electronic embodiment may be implemented on a variety of computing devices and systems, wherein these computing devices include the appropriate processing mechanisms and computer-readable media for storing and executing computer-readable instructions, such as programming instructions, code, and the like. As shown in FIG. 5, personal computers 900, 944, in a computing system environment 902 are provided. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in other transport mechanisms and include any information delivery media, wired media (such as a wired network and a direct-wired connection), and wireless media. Computer-readable media may include all machine-readable media with the sole exception of transitory, propagating signals. Of course, combinations of any of the above should also be included within the scope of computer-readable media.

The computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data and other instruction-based computer-readable codes.

With continued reference to FIG. 5, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 5 provide storage of operating systems, computer-readable instructions, application programs, data structures, program modules, program data and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-screen, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938 through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communicate through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby, forming a specialized and particular computing system. Accordingly, the presently-invented method and system may include one or more computers 900 or similar computing devices having a computer-readable storage medium capable of storing computer-readable program code or instructions that cause the processing unit 904 to execute, configure or otherwise implement the methods, processes, and transformational data manipulations discussed hereinafter in connection with the present invention. Still further, the computer 900 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method for providing a multi-stage high-low game, comprising:
(a) providing a physical gaming surface;
(b) providing, on the physical gaming surface, a card comprising a value;
(c) providing, on the physical gaming surface, a next card comprising a value, wherein the next card is provided after an indication of high or low is received;
(d) repeating step (c) until at least one of the following occurs: the indication is low and the value of the next card is greater than the value of the next card previously provided, the indication is high and the value of the next card is less than the value of the next card previously provided, or a predetermined number of next cards are provided;
(e) providing at least one unit of payment to at least one player;
(f) repeating step (c) until at least one of the following occurs: the indication is low and the value of the next card is greater than the value of the next card previously provided, the indication is high and the value of the next card is less than the value of the next card previously provided, or a second predetermined number of next cards are provided; and
(g) providing at least one second unit of payment to the at least one player, wherein the at least one second unit of payment has a value that is greater than a value of the at least one unit of payment.

2. The method of claim 1, further comprising:
(h) repeating step (c) until at least one of the following occurs: the indication is low and the value of the next card is greater than the value of the next card previously provided, the indication is high and the value of the next card is less than the value of the next card previously provided, or a third predetermined number of next cards are provided; and
(i) providing at least one third unit of payment to the at least one player, wherein the at least one third unit of payment has a value that is greater than a value of the at least one second unit of payment.

3. The method of claim 2, further comprising:
(j) repeating step (c) until at least one of the following occurs: the indication is low and the value of the next card is greater than the value of the next card previously provided, the indication is high and the value of the next card is less than the value of the next card previously provided, or a fourth predetermined number of next cards are provided; and
(k) providing at least one fourth unit of payment to the at least one player, wherein the at least one fourth unit of payment has a value that is greater than a value of the at least one third unit of payment.

4. The method of claim 1, wherein the physical gaming surface comprises at least one betting grid, the at least one betting grid comprising a plurality of portions.

5. The method of claim 4, wherein, after step (d), step (f), or any combination thereof, the method further comprises moving a position of a wager on the physical gaming surface from a first portion of the at least one betting grid to a second portion of the at least one betting grid.

6. The method of claim 1, wherein the indication comprises a position of an indicator unit.

7. The method of claim 6, wherein the indicator unit comprises a disk, the disk comprising at least one side associated with a low indication, and at least one other side associated with a high indication.

8. A method for providing a high-low card game having a plurality of stages, each stage of the plurality of stages comprising a plurality of cards associated with a plurality of guesses, wherein each stage ends when the plurality of cards are provided without a player making an incorrect guess, wherein the player provides a wager to play the game, and wherein each end of each stage is associated with a payment, the method comprising:
providing a physical gaming surface;
providing, on the physical gaming surface after the player provides the wager, the plurality of cards for each stage of the plurality of stages, wherein each stage comprises providing each card of the plurality of cards after a guess of high or low is made by the player and removing the wager if at least one of the following occurs: the player guessed low and a next card of the plurality of cards provided has a value higher than a value of a card previously provided, or the player guessed high and the next card of the plurality of cards provided has a value higher than the value of the card previously provided; and
providing a payment to the player at the end of each stage of the plurality of stages if the wager has not yet been removed, wherein the payment is increased at every stage of the plurality of stages.

9. The method of claim 8, wherein the plurality of cards for each stage of the plurality of stages comprises at least three cards.

10. The method of claim 8, wherein the physical gaming surface comprises at least one betting grid for at least one player, the at least one betting grid comprising at least two wager portions and at least two payment portions.

11. The method of claim 10, further comprising moving the wager from a first portion of the at least one betting grid to a second portion of the at least one betting grid at the end of at least one stage of the plurality of stages.

12. The method of claim 8, further comprising accepting a new wager from the player and adding the new wager to the wager if a card provided has a value equal to the value of the card previously provided.

13. The method of claim 8, wherein the plurality of stages comprises four stages, and wherein the payment for the first stage is equal to the wager, and wherein the payment for the second stage is twice the wager, and wherein the payment for the third stage is triple the wager, and wherein the payment for the fourth stage is quadruple the wager.

14. A multi-stage high-low game, comprising:
a plurality of indicator units, each indicator unit of the plurality of indicator units configured to provide an indication of high or low;
a physical gaming surface comprising a player-side portion and a dealer-side portion, the player-side portion comprising a plurality of betting grids positioned in a plurality of player positions, the dealer-side portion comprising a plurality of indicia adapted for receiving a plurality of playing cards, the plurality of playing cards including a predetermined number of playing cards for each stage of the game, wherein each betting grid of the plurality of betting grids comprises a plurality of betting portions adapted to receive at least one wagering unit, and a plurality of payment portions adapted to receive a plurality of incremental payments.

15. The multi-stage high-low game of claim 14, further comprising a plurality of playing cards and a plurality of wagering units.

16. The multi-stage high-low game of claim 14, wherein the physical gaming surface further comprises a plurality of high indication portions and a plurality of low indication portions, wherein each of the high indication portions and low indication portions are adapted to receive at least one indicator unit of the plurality of indicator units.

17. A computer-implemented method for providing a virtual multi-stage high-low game, comprising:
(a) displaying a virtual gaming surface with at least one display device;
(b) displaying, on the virtual gaming surface, a graphical representation of a card associated with a value;
(c) displaying, on the virtual gaming surface, a graphical representation of a next card associated with a value, wherein the graphical representation of the next card is displayed after an indication of high or low is received;
(d) repeating step (c) until at least one of the following occurs: the indication is low and the value of the next card is greater than the value of the card or the next card previously displayed, the indication is high and the value of the next card is less than the value of the card or the next card previously displayed, or a predetermined number of next cards are displayed;
(e) allocating at least one first unit of payment to an electronic player balance for at least one player;
(f) repeating step (c) until at least one of the following occurs: the indication is low and the value of the next card is greater than the value of the next card previously displayed, the indication is high and the value of the next card is less than the value of the next card previously displayed, or a second predetermined number of next cards are displayed; and
(g) allocating at least one second unit of payment to the electronic player balance, wherein the at least one second unit of payment has a value that is greater than a value of the at least one first unit of payment.

18. The computer-implemented method of claim 17, further comprising:
(h) repeating step (c) until at least one of the following occurs: the indication is low and the value of the next card is greater than the value of the next card previously displayed, the indication is high and the value of the next card is less than the value of the next card previously displayed, or a third predetermined number of next cards are displayed; and
(i) allocating at least one third unit of payment to the electronic player balance, wherein the at least one third unit of payment has a value that is greater than a value of the at least one second unit of payment.

19. The method of claim 18, further comprising:
(j) repeating step (c) until at least one of the following occurs: the indication is low and the value of the next card is greater than the value of the next card previously displayed, the indication is high and the value of the next card is less than the value of the next card previously displayed, or a fourth predetermined number of next cards are displayed; and
(k) allocating at least one fourth unit of payment to the electronic player balance, wherein the at least one fourth unit of payment has a value that is greater than a value of the at least one third unit of payment.

20. The method of claim 17, wherein the at least one first unit of payment and the at least one second unit of payment are temporarily allocated to the electronic player balance, the method further comprising enabling the at least one player to collect the electronic player balance after step (e) but before step (f).
